(19) United States
(12) Patent Application Publication
(10) Pub. No.: US 2007/0088610 A1
(43) Pub. Date: Apr. 19, 2007

(54) System and method for electronic reservation of real-time redemption of advertiser's loyalty points for rewards and discount coupons and gift card certificates

(76) Inventor: Timothy T. Chen, New York, NY (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/639,018

(22) Filed: Dec. 14, 2006

Related U.S. Application Data
(63) Continuation-in-part of application No. 11/053,741, filed on Feb. 8, 2005.
Application No. 11/053,741 is a continuation-in-part of application No. 10/072,647, filed on Feb. 6, 2002.

(51) Int. Cl. G06Q 30/00

(52) U.S. Cl. 705/14

(57) ABSTRACT

A system and method enable a consumer to redeem loyalty points and coupons. The consumer is presented with a choice of electronic loyalty point redemption options and coupons, specific to the consumer and based on a behavioral purchasing rating system. The consumer's selections are transmitted to the participating vendor so the consumer can immediately pick up the consumer's selection from the vendor or utilize the desired coupons. The vendor can initiate new loyalty point redemption options dynamically. The vendor can accurately identify whether or not a promotion drove the consumer to the vendor's store through time and membership identification correlation.

### CROSS REFERENCE TO RELATED APPLICATIONS

This application is a continuation-in-part of U.S. patent application Ser. No. 11/053/741, filed Feb. 8, 2005 which, in turn, is a continuation-in-part of 10/072,647, filed Feb. 6, 2002, the entire disclosure of which is incorporated by reference herein as if being set forth in its entirety.

### BACKGROUND OF THE INVENTION

1. Field of the Invention

The present invention relates to marketing systems and methods and more particularly, to the redemption of specific consumer incentives on a real-time basis and the evaluation of their efficacy.

2. Description of the Prior Art

Credit card companies and vendors typically offer loyalty programs to consumers to encourage them to continue purchasing. Consumers earn loyalty points which correspond to the amount of dollars they have spent. Generally, these loyalty points translate to a set of generic reward redemption products that are offered by the credit card company and/or its affiliates, a ticket of reservation for a hotel stay, car rental, airfare, or gift card/certificates that are worth a specific amount of cash value when redeemed at a local store merchant. This gives the consumer the opportunity to acquire an incentive product or reward, without having to pay cash or have the ability to receive a discount for it. For example, a consumer who charged $500 worth of purchases or spent $500 at a particular store would earn 500 loyalty points from a specific program of the consumer's choosing, which can be accumulated and later used for redemption from the above mentioned methods. Consumers spending more money earn greater amounts of loyalty points and can be redeemed for more valuable incentive products or receive greater cash value gift cards for discounts at local stores.

Typically, redemptions from electronic means such as the Internet/mobile access have not been real-time. A consumer who redeems a generic product must first contact the loyalty points program via phone/Internet/mobile access, select the product from a set of products that are offered by the loyalty points program, and then receive the product by mail after many days. This is even consistent with consumers who redeem an airline ticket, hotel stay, or car rental, because after the reservation is made, the consumer must wait until the day of the reservation to claim the reward.

Specific grocery stores have introduced a method to redeem loyalty points for discounts of specific items when a consumer arrives at the grocery store. For example, grocery store AB has its own loyalty program, and stipulates that this week, consumers can redeem 100 points and get $1 discount on store branded vegetable soup. Without redeeming points, the cost to the consumer will be $3. With redeeming points the cost to the consumer will be $2. This results in the need of the consumer to physically request the discount and the discount is then administered by the store checkout attendant. This does not involve an ability of the consumer to pre-determine redeeming a promotion through electronic means so that the store checkout attendant already knows that the consumer will redeem the reward or discount.

Additionally, it is not practical to establish limits on the number of persons who can redeem loyalty points for a particular product in a fair and efficient way online or at local stores. Consumers may redeem the product on a first-come-first-serve basis but this may anger consumers if there is not enough product to accommodate them. For any given promotional product, it remains unclear whether the promotional product is actually at the store upon the consumer's arrival. It is also very difficult to gauge which consumer actually received a promotion to collect data to cater to consumer preferences when gift card certificates are brought into the store, since most gift certificates are not associated with a specific consumer's purchasing details because they are generic in nature.

Also, today, it is not possible for a vendor to implement changes to a loyalty program redemption “on the fly,” i.e. dynamically. For example, a restaurant owner may observe that his or her restaurant is empty at 7PM on a Tuesday evening and he or she would like to generate business by modifying the loyalty program, at that very moment. There is currently no means for notifying the consumer of this instant change and thereby driving the consumer into the store. In another example, if the restaurant unveils a loyalty redemption promotion for a free cheesecake for a specific day or time for all consumers. However, overwhelming responses limits the restaurant's ability to seat consumers above its capacity. Currently, there is not a methodology where the restaurant can change the redemption offer and add a limit count for the amount of possible redemptions for local stores. Current loyalty programs are inflexible and cannot meet the ongoing needs of the vendor.

Accordingly, there exists a need in the art to: enable consumers to realize value by quickly and easily redeeming loyalty points and coupons; to enable advertisers and vendors to monitor the redemption, to better measure the effectiveness of these incentives; and to enable vendors to be able to modify their incentive programs instantaneously, to effectively drive consumers to their stores.

### SUMMARY OF THE INVENTION

The present invention discloses a method and system for enabling a consumer to redeem loyalty points at local stores. The method and system include providing the consumer with a choice of loyalty point redemption options, redeemable for a product or service, at one or more participating vendors. When the consumer selects the desired option via electronic means such as the Internet or wireless access from a mobile phone, this is recorded and transmitted to the related participating vendor, or the information is kept in a database that can be accessed by the participating vendor at any time. Accordingly, the consumer is enabled to immediately redeem the loyalty points for the incentive product selected and also thorough evaluation of the effectiveness of the incentive, which is driving the consumer to the vendor's store for pickup, a better measure of the incentive can be accomplished. The loyalty points can be immediately deducted from the consumer's account as he indicates his preference for redemption through electronic means. The vendor may also make available to the consumer new or modified loyalty point redemption options, or set limits to the amount of consumers that can redeem a certain loyalty redemption, at will and instantaneously, using a POS device, a website, using mobile wireless access, or other input methods.

The present invention also discloses a method and system for enabling a consumer to select and redeem a discount coupon or gift card certificate from a selection of personalized coupon redemption options, based upon a behavioral purchasing rating system. The option selected is recorded and transmitted to the related participating vendor, kept in a database that can be accessed by the vendor at any time and/or alternatively, a barcode is also transmitted consumer's portable device. It can then be associated with the consumer's identification, eliminating the potential for fraud, and scanned into a POS device or other register so that the appropriate discount coupon or gift card certificate may be applied to the consumer's purchase on a real-time basis.

### BRIEF DESCRIPTION OF THE DRAWINGS

The invention will be more fully understood and further advantages will become apparent when reference is had to the following detailed description and the accompanying drawings, in which like numerals refer to like parts, and in which:

FIG. 1 is a block diagram of the present invention illustrating a system for redeeming loyalty points;

FIG. 2 is a flow diagram of the present invention illustrating a method of redeeming loyalty points;

FIG. 3 is a flow diagram of the present invention illustrating a method for redeeming coupons;

FIG. 4 is a block diagram of the present invention illustrating a system of redeeming coupons; and

FIG. 5 is an exemplary screen shot of the loyalty points redemption user interface.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical marketing or advertising method and system incorporating the Internet. Those of ordinary skill in the art will recognize that other elements are desirable and/or required in order to implement the present invention. However, because such elements are well known in the art, and because they do not facilitate a better understanding of the present invention, a discussion of such elements is not provided herein.

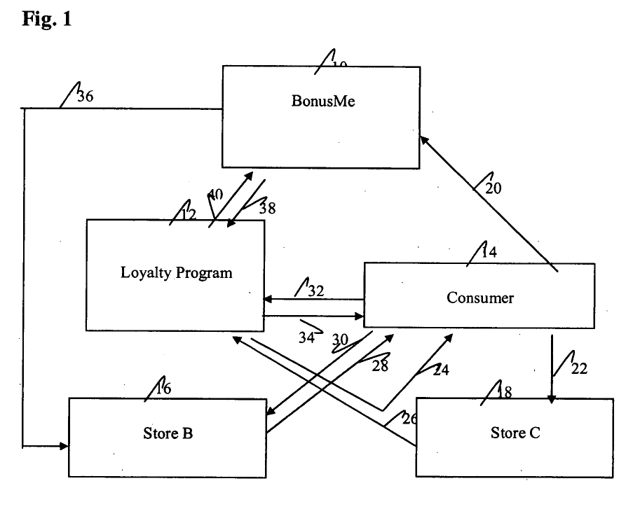

FIG. 1 is a block diagram illustrating a system for enabling a consumer to redeem loyalty points without the delay inherent in the prior art. The Consumer 14 earns loyalty points by spending money 22 at Store C 18. The Loyalty Program 12 credits the Consumer 14 with loyalty points 24 when the Consumer 14 shops with the loyalty program card 22. A Loyalty Program 12 is implemented by a credit card company, an airline, or a retailer, for example. The Consumer 14 can also earn extra points by shopping at specific stores. Store C 18 pays a fee to the credit card company for each item charged and may also pay the Loyalty Program 12 for extra points Store C 18 gives to the Consumer 14 to further enhance incentives for the Consumer 14. Facilitated by BonusMe 10, Store C 18 can also modify the loyalty point redemption options available to the Consumer 14 through the Internet, mobile phone, and other electronic means.

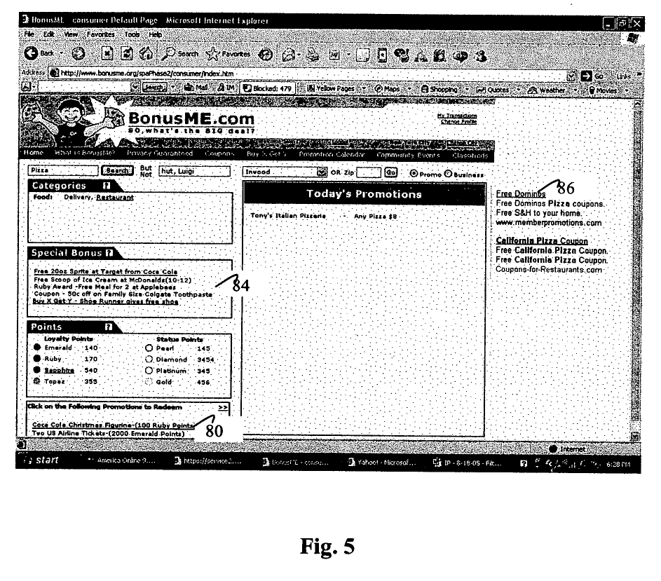

The Consumer 14 can redeem loyalty points directly from the Loyalty Program 12 in exchange for offers 32 by accessing the Internet, mobile phone, or other electronic means. Alternatively, the Consumer 14 can redeem loyalty points 20 through BonusMe 10 and secure a promotion on a real-time basis at an offline store 16. BonusMe 10 facilitates the transaction of dollars 36 40 from the Loyalty Program 12 to Store B 16 for items redeemed by the Consumer 14 and deducts points 38 from the Consumer's 14 account. As soon as the Consumer 14 clicks on the hyperlink to redeem the promotion FIG. 5 80, the Consumer 14 can pick up the item from Store B FIG. 1 16 on a real-time basis.

Real-time redemption utilizing electronic means to obtain a promotion product from a local store, as described above, does not occur in the prior art. So for example, a credit card company might offer a consumer a briefcase as a reward for charging a threshold dollar amount but the briefcase company does not know who the consumer is and the consumer cannot visit the briefcase company to pick up the reward. In the case of the prior art, the credit card company, or a third-party to whom the credit card company has contracted out the function, handles point redemption. The vendor of the promotional item has no connection with the consumer, does not know who the consumer is and therefore, the consumer cannot pick up the promotional item directly from the vendor without the assistance of a printed medium such as a paper-based coupon for verification purposes. When the consumer wishes to redeem a promotional item, the Loyalty Program 12 must first be notified. The Loyalty Program 12 can then send the consumer a gift card, which the consumer can present to the vendor in order to receive the promotional item, or the Loyalty Program 12 can arrange for the item to be mailed to the consumer from the vendor.

An example of a product, which can be redeemed for loyalty points is a Coca-Cola® figurine FIG. 5 80. When the Consumer 14 clicks on the hyperlink for the figurine, the consumer redeems the promotion FIG. 1 20 from the BonusMe system 10 or from the Loyalty Program 12 and the redemption will now be displayed in the Special Bonus Window FIG. 5 84, which is a customized display and tracking of the Consumer's 14 redemption. Store B FIG. 1 16 can further control the promotion that are given by limiting it to the first 10 people to click, for example. However, the Consumer 14 need not rush to Store B 16 because the product is reserved for the Consumer 14, or Consumer 14 can be near or at Store B 16, click on the promotion while Consumer 14 is at Store B 16, and pick up the redeemed item immediately. After the Consumer 14 or checkout attendant scans Consumer's 14 membership card or manually enters a personal identification number that correlates the Consumer 14 to redemptions on a touchscreen device, which can be a PDA, small computer, POS entry system, mobile phone, etc. then the promotion which has been electronically redeemed by the Consumer 14 will appear. This can correlate the Consumer 14 to specific promotions that may only be available to the Consumer 14 at Store B 16, and happens on a real-time basis electronically. In contrast to the prior art, in the present invention, the promotional offer is accepted online and immediately by the Consumer 14. In the prior art, the offer is only accepted when the Consumer 14 is at the checkout counter of Store B 16.

When the Consumer 14 displays the Consumer's 14 loyalty program card for scanning, Store B 16 identifies the Consumer 14 and recognizes that Consumer 14 is the party who is entitled to the reward. Accordingly, the present invention not only avoids the delay inherent in the system of the prior art, but also determines that the promotional item, i.e. the figurine, is driving the Consumer 14 to Store B 16, where it is quite likely that additional purchases will be made. In contrast, in the prior art, the consumer is already in the store, at the time and place when the promotional item or discount is offered. The consumer may be shopping in the store for reasons completely unrelated to the promotion, so there is no way of ascertaining the true effect of the promotion.

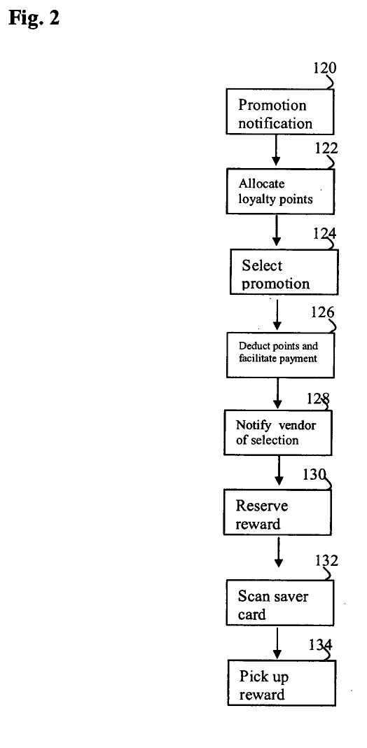

With reference to FIG. 2, in the present method, BonusMe 10 facilitates the dollar flow, loyalty flow, and point flow between the Loyalty Program 12, the Consumer 14, Store B 16, and Store C 18. In this example, Store B 16 and Store C 18 are representative of a plurality of participating stores. Store B 16 notifies BonusMe 10 of a new promotional item and the points to be charged step 120. Generally, the points to be charged are for the promotional item can dynamically vary from day to day, and the promotional item can also vary from day to day. This is in contrast to the prior art where promotional items are redeemed for static point amounts that are generally availed for long periods of time. Also, in the prior art, points can only be redeemed for promotional items offered by a single store chain, for example, D′ Agostinos Grocery Store®. The present invention promotes real time dynamic rewards at many different stores.

Accordingly, in the present invention, Store B 16 can leverage its promotions more efficiently. If Store B is a restaurant, for example, Store B 16 can dynamically adjust downward the number of points it charges to procure the promotional item, such as a pizza, with the hope of driving more customers to the store. Likewise, if Store B 16 is a grocery store, when there is an overstock of a perishable promotion, such as bananas, Store B 16 can adjust the points downward with the hope of reducing its inventory of the good. Store C 18 can also dynamically adjust upward the points it allocates a consumer as bonus points in the hopes of differentiating itself from other stores. So for example, if Store C 18 normally allocates 10 points for every dollar spent on candy corn during Halloween, it can double this allocation, giving 20 points for every dollar spent, to clear out excess inventory.

The present invention tracks the money the consumer spends at the Vendor 18 using the loyalty program card and allocates loyalty points to the consumer's loyalty point account step 122. The consumer selects a promotional item using the BonusMe interface step 124 redeeming a predetermined amount of loyalty points. BonusMe deducts points from the consumer's loyalty point account step 126 and facilitates payment from the Loyalty Program 12 to the Vendor 18 for the promotional item. BonusMe notifies the Vendor 18 of the consumer's selection step 128. The Vendor 18 sets aside the promotional item step 130. The consumer visits the Vendor 18 and the Vendor 18 scans the consumer's Loyalty Program 12 (Saver) card to identify the Consumer 14 step 132. The Consumer picks up the promotional item step 132 and the redemption fulfillment is recorded.

Because BonusMe tracks and controls the entire redemption process, the efficacy of the promotion can be measured, evaluated, and finely tuned. BonusMe records the Consumer's 14 click stream in the process of selecting the promotion from the BonusMe website FIG. 2 step 124 FIG. 6, so that redeeming Consumer's 14 purchasing and promotion interests can be evaluated. BonusMe also records the time lag between selecting the promotion step 124 and picking up the reward step 134 as well as whether any additional items were purchased in the store step 132. In this way, BonusMe can evaluate whether the promotion in fact drove the consumer to the store and whether it resulted in additional purchasing. The shorter the time lag, the more likely that the promotion prompted the store visit. Also, because promotions are dynamic and some are only available for short time periods, the connection between a promotion and a store visit can be more confidently ascertained. If a consumer: 1) logs on to the BonusMe website at 10 PM; 2) selects a free pizza coupon for redemption at 10:05 when the window for the promotion is 10 PM to 12 midnight; and 3) redeems the pizza at 10:20; the effectiveness of the promotion is clear.

The prior art relies upon Cost per Impression (CPM) wherein advertisers charge vendors each time an ad is shown. This metric does not take into account any sort of tracking or follow-up on the consumer's response to the ad. It is unknown whether the consumer actually purchases anything based on the ad. Also, companies such as Google® charge vendors for advertising based upon Cost per Click (CPC). Each time a consumer clicks on an advertising link, Google® charges the vendor. For online purchasing, the efficacy of the purchase can be tracked, as cookies within a browser can verify whether the link led to an actual purchase. Of course, there is no clear connection between clicking on an ad and purchasing an item at a local store displayed in the ad. The present invention employs Cost per Delivery (CPD), which is a major improvement over the prior art. CPD tracks the effectiveness of a promotion by measuring exactly what was purchased at a local store and correlates the time that a Consumer 14 views an advertisement, redeems the promotions, and their offline responses to the promotion which ultimately results in physical obtainment of the promotion at the Store 18.

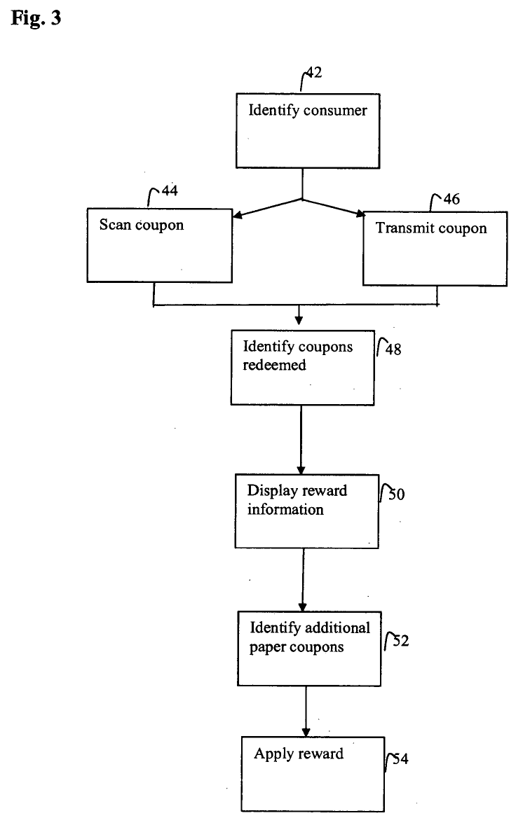

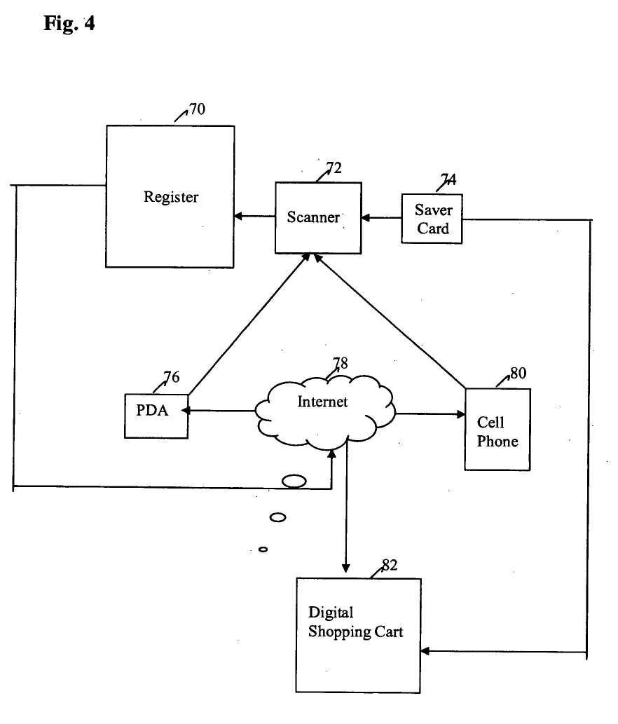

In addition to tracking redemption of promotional items, the present invention also tracks the redemption of electronic coupons, in the same manner. When the consumer enters a participating store FIG. 1 18, the consumer can scan the consumer's saver card FIG. 4 74, FIG. 4 82 into a digital shopping cart FIG. 4 82. Digital shopping carts or smart shopping carts such as Save-A-Lot from IBM or the U-Scan Shopper from Fujitsu are well-known in the art. The digital shopping cart 82 displays to the consumer the promotions available to the consumer by product and their location in the store FIG. 3 50.

The consumer may also have redeemed certain promotions or coupons using the BonusMe website, FIG. 5 86, FIG. 2 124. If the Consumer 14 is scanning the Consumer's 14 order using the digital shopping cart 82, the prices will reflect the personalized promotions and discounts available to the particular consumer FIG. 3 46 48 50 54. Alternatively, using a cell phone FIG. 4 80, the consumer may dial a pre-assigned telephone number, press a designated key sequence, or use the Web access feature of the cell phone FIG. 4 80 to enter the consumer's identification number, which is also recorded on the saver card 74. The consumer can then download a bar code, corresponding to an electronic coupon redeemed online by the consumer, to the cell phone 80 FIG. 3 46. Alternatively, the consumer may also download a barcode corresponding to a redeemed coupon using a Web-enabled PDA 76.

Scanning bar codes from a variety of display devices is well-known in the art. The bar code on the PDA 76 or cell phone 80 is scanned at the scanner 72 and read by a POS device, which generates the appropriate price FIG. 3 44. The POS device records the time and place of redemption fulfillment. Where a POS is not available, other types of registers FIG. 4 70 or scanners 72 can be used to identify the bar code corresponding to the redeemed coupon FIG. 3 48. This is helpful for smaller businesses, or business in less developed nations, where POS devices are not frequently available. Of course other means of identifying the consumer or the coupon can be employed such as RFID. Connections to the Web may be through a network, directly via cable or satellite, or wireless. In addition, paper coupons may be used to further reduce the price charged the consumer FIG. 3 52.54

Accordingly, the effect of the coupon can be judged because there is a record of coupons redeemed by the consumer, prior to entering the store, and the use of the coupons is effectively limited in accordance with the participating vendor's intent. It is not possible for a consumer to use the same coupon more than once. Furthermore, consumers who visit a participating vendor, only after redeeming a coupon, are easily identified. The vendor may then decide not to offer the consumer further coupons because the coupons have not succeeded in instilling store loyalty in the consumer.

Those of the ordinary skill in the art will recognize that many modifications and variations of the present invention may be implemented without departing from the spirit or scope of the invention. The foregoing description and the following claims are intended to cover all such modifications and variations.

What is claimed is:

1. A method for enabling a consumer to redeem loyalty points, comprising the steps of:
a. providing the consumer with a choice of loyalty point redemption options electronically, specific to the consumer, each related to a predetermined number of loyalty points that can be changed dynamically and a behavioral purchasing rating system, redeemable at one or more participating vendors;
b. providing the consumer with a means for selecting at least one of the loyalty point redemption options electronically;
c. recording the one or more options selected; and
d. electronically transmitting the one or more options selected to the related participating vendor;
e. whereby the consumer can immediately receive the product for the redeemed loyalty points.

2. The method of claim 1 wherein at least one option is selectable for offline store redemption by a preset number of consumers.

3. The method of claim 1 wherein the consumer redeems the consumer's loyalty points for a designated product at offline stores.

4. The method of claim 3 wherein the consumer acquires the product from the related participating vendor's store.

5. The method of claim 1 wherein the one or more options selected by the consumer are transmitted to the point-of-sale machine of the related participating vendor.

6. The method of claim 1 wherein the one or more options selected by the consumer are queried through a third party database when the consumer elects to redeem a product from the related participating vendor's store

7. The method of claim 1 wherein the consumer selects the option by clicking the consumer's mouse on the desired option displayed on a website.

8. The method of claim 1 wherein the consumer selects the option by using selection buttons on the desired option's mobile device

9. The method of claim 1 wherein the participating vendor provides the redeeming consumer with additional loyalty points.

10. The method of claim 4 wherein the vendor's store is an offline, brick-and-mortar store

11. The method of claim 1 wherein the participating vendor can modify the loyalty point redemption options available to the consumer in real time.

12. The method of claim 9 wherein the participating vendor can enter the modification on a POS device.

13. The method of claim 9 wherein the participating vendor can enter the modification on a mobile phone

14. The method of claim 9 wherein the participating vendor can enter the modification on a computer from the related participating vendor

15. The method of claim 6 wherein the consumer's click stream from login to redemption at the offline store is recorded.

16. The method of claim 11 wherein a time period from login to redemption is measured and recorded.

17. The method of claim 1 wherein the consumer's loyalty point redemption options can be viewed and modified on a PDA

18. The method of claim 1 wherein the consumer's loyalty point redemption options can be viewed and modified on a portable computer

19. The method of claim 1 wherein the consumer's loyalty point redemption options can be viewed and modified through a kiosk that is located in a public facility

20. The method of claim 1 wherein the consumer's loyalty point redemption options can be viewed and modified through a mobile phone

21. The method of claim 5 wherein the participating vendor can view the consumer's loyalty points on a POS device.

22. The method of claim 1 wherein the participating vendor can view the consumer's loyalty point balance on a PDA.

23. The method of claim 1 wherein the participating vendor can view the consumer's loyalty point balance on a computer.

24. The method of claim 1 wherein the consumer can view the consumer's loyalty point balance on a mobile phone.

25. The method of claim 1 wherein the loyalty point redemption options are displayed on the consumer's digital shopping cart.

26. The method of claim 1 wherein the vendor can enter the loyalty point redemption option on a PDA.

27. The method of claim 1 wherein the vendor can enter the loyalty point redemption option on a computer.

28. The method of claim 1 wherein the vendor can enter the loyalty point redemption option on a mobile phone

29. The method of claim 1 wherein the vendor can enter the loyalty point redemption option on a POS system.

30. A method for enabling a consumer to redeem at least one coupon comprising the steps of:
a. providing the consumer with a choice of coupon redemption options electronically, specific to the consumer, each related to a behavioral purchasing rating system, redeemable at one or more participating vendors;
b. providing the consumer with a means of selecting at least one of the coupons for redemption electronically;
c. recording the one or more coupons selected;
d. electronically transmitting a barcode representing the coupon selected to the consumer's portable device;
e. enabling the participating vendor to scan the barcode into a register; and
f. whereby the appropriate coupon may be electronically applied to the consumer's purchase.

31. The method of claim 30 wherein the portable device is a PDA.

32. The method of claim 30 wherein the portable device consists of a touchscreen and mobile computer

33. The method of claim 30 wherein the portable device is a mobile phone.

34. The method of claim 30 wherein the coupon options available are displayed on a digital kiosk at the participating vendor's location.

35. The method of claim 30 wherein the coupon options available are displayed on the POS at the participating vendor's location

36. The method of claim 30 wherein the coupon options available are displayed on a mobile phone at the participating vendor's location

37. The method of claim 30 wherein the coupon options available are displayed on the computer at the participating vendor's location

38. The method of claim 30 wherein the store location of each product corresponding to a coupon is displayed on a digital shopping cart.

39. A method for determining the efficacy of a personalized promotional incentive comprising the steps of:
a. offering the personalized incentive to at least one participating consumer offsite from a vendor;
b. providing a means for selecting the incentive offsite from the vendor;
b. providing a means for redeeming the incentive onsite at the vendor;
c. recording when the incentive is selected by the consumer offsite from the vendor;
d. recording when the incentive is redeemed by the consumer onsite at the vendor;
e. calculating a time differential between the offsite selection of the incentive and the onsite redemption of the incentive; and
f. determining the level of effectiveness of the incentive, in driving the consumer to the vendor, based upon predetermined timing parameters.

40. A system for enabling a consumer to redeem loyalty points from a vendor comprising:
a. a loyalty program portion for providing the consumer with a choice of loyalty point redemption options, each related to a behavioral purchasing system and specific to the consumer;
b. a facilitator portion for:
i. providing the consumer with a means for selecting at least one of the loyalty point redemption options;
ii. recording the one or more options selected; and
iii. transmitting the one or more options selected to the related participating vendor;
c. whereby the consumer can immediately redeem the loyalty points.

41. The system of claim 40 wherein at least one option is selectable for redemption by a preset number of consumers.

42. The system of claim 40 wherein the consumer redeems the consumer's loyalty points for a designated product at offline stores.

43. The system of claim 40 wherein the consumer acquires the product from the related participating vendor's store.

44. The system of claim 40 wherein the one or more options selected by the consumer are transmitted to the point-of-sale machine of the related participating vendor.

45. The system of claim 40 wherein one or more options selected by the consumer are queried through a third party database when the consumer elects to redeem a product from the related participating vendor

46. The system of claim 40 wherein the consumer selects the option by clicking the consumer's mouse on the desired option displayed on a website.

47. The method of claim 40 wherein the consumer selects the option by using selection buttons on the desired option's mobile device

48. The system of claim 40 wherein the participating vendor provides the redeeming consumer with additional loyalty points.

49. The system of claim 40 wherein the vendor's store is an offline, brick-and-mortar store.

50. The system of claim 40 wherein the participating vendor can modify the loyalty point redemption options available to the consumer in real time.

51. The system of claim 40 wherein the participating vendor can enter the modification on a POS device.

52. The system of claim 40 wherein the participating vendor can enter the modification on a mobile phone

53. The system of claim 40 wherein the participating vendor can enter the modification on a computer from the related participating vendor

54. The system of claim 40 wherein the consumer's click stream from login to redemption at the offline store is recorded.

55. The system of claim 40 wherein a time period from login to redemption is measured and recorded.

56. The system of claim 40 wherein the consumer's loyalty point redemption options can be viewed and modified on a PDA.

57. The system of claim 40 wherein the consumer's loyalty point redemption options can be viewed and modified on a portable computer.

58. The system of claim 40 wherein the consumer's loyalty point redemption options can be viewed and modified through a kiosk that is located in a public facility

59. The system of claim 40 wherein the consumer's loyalty point redemption options can be viewed and modified through a mobile phone

60. The system of claim 40 wherein the participating vendor can view the consumer's loyalty points on a POS device.

61. The system of claim 40 wherein the participating vendor can view the consumer's loyalty point balance on a PDA.

62. The system of claim 40 wherein the consumer can view the consumer's loyalty point balance on a mobile telephone.

63. The system of claim 40 wherein the participating vendor can view the consumer's loyalty point balance on a computer.

64. The system of claim 40 wherein the loyalty point redemption options are displayed on the consumer's digital shopping cart.

65. The system of claim 40 wherein the vendor can enter the loyalty point redemption option on a PDA.

66. The system of claim 40 wherein the vendor can enter the loyalty point redemption option on a computer.

67. The system of claim 40 wherein the vendor can enter the loyalty point redemption option on a mobile phone

68. The system of claim 40 wherein the vendor can enter the loyalty point redemption option on a POS system.

69. A system for enabling a consumer to redeem at least one discount coupon from a vendor comprising:
a. a first identification portion for identifying the consumer;
b. a transmission portion for transmitting an electronic representation of the consumer's coupon information to the vendor;
c. a scanning portion for scanning a bar-coded representation of the consumer's coupon displayed on a portable device;
d. a display portion for displaying the transmitted and bar-coded coupon information;
e. a second identification portion for identifying paper coupons available to the consumer; and
f. a reward portion for applying the digital representations of the consumer's coupon and the available paper coupons to the purchase price of the related goods.
